(19) United States
(12) Patent Application Publication
(10) Pub. No.: US 2010/0140349 A1
(43) Pub. Date: Jun. 10, 2010

(54) SYSTEM, METHOD, AND COMPUTER SOFTWARE CODE FOR RE-USING A COIN IN A COIN-OPERATED SYSTEM OR APPARATUS

(76) Inventors: Kern Jennison, Daytona Beach, FL (US); Justin Jennison, Daytona Beach, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/632,763

(22) Filed: Dec. 7, 2009

Related U.S. Application Data
(60) Provisional application No. 61/120,282, filed on Dec. 5, 2008.

(51) Int. Cl. G06K 5/00; G07F 7/04; G06F 19/00

(52) U.S. Cl. 235/380; 194/206; 194/217

(57) ABSTRACT

A system for re-using a coin in an apparatus that requires the coin to operate the apparatus, the system including a currency insertion device, an activation device configured to activate the apparatus once currency provided to the currency insertion device has been validated, a holding bin configured to hold at least one coin, and a collection device configured to capture the at least one coin when activation ceases. A method and computer software code, stored on a computer readable media and executable with a processor, are also disclosed.

### CROSS-REFERENCE TO RELATED APPLICATIONS

This application claims the benefit of U.S. Provisional Application No. 61/120,282 filed Dec. 5, 2008, and incorporated herein by reference in its entirety.

### BACKGROUND OF THE INVENTION

Embodiments of this invention relate generally to an apparatus that requires a coin as a part of its operation, such as but not limited to a gaming system, and, more specifically, to an apparatus configured to re-use a same coin when the coin-operated apparatus is activated with another form of currency.

Coin-operated apparatus are commonly known, especially with respect to such apparatus used for entertainment. One such type of coin-operated apparatus include, but are not limited to action skill games, action target games, action-type target games, amusement game machines, arcade games, arcade-type electronic video games, coin-operated video games. Such apparatus will be generally referred to as gaming apparatus. Other types of coin-operated apparatus are also known, such as, but not limited to, public operated laundry machines. The coins used in coin-operated apparatus may be coin currency or tokens, such as gaming tokens.

Prior art coin-operated apparatus typically included an insertion location for placing coins to operate the apparatus. Once inserted the coins remained in a bin until a maintainer or owner of the money-operated apparatus removed the coins. Many such prior art coin-operated apparatus can now be referred to as money-operated apparatus since many now include an option to insert coins, paper currency, and/or a credit or debit card to operate the apparatus. For credit or debit cards, a card insertion device is part of the money-operated apparatus. Instead of collecting coins, or paper currency in a bin, such apparatus are in communication with a banking network and money required to operate the money-operated apparatus is deposited into the maintainer or owner's bank account, or another designated bank account.

With respect to gaming apparatus, some games still exist where coins are an integral part of playing the gaming apparatus. For example, a coin may be the instrument that is used in the game to determine whether a user wins or loses, depending on a final location of the coin within the gaming apparatus. Because the coin is required, having a card insertion device to allow the gaming apparatus to operate without a coin is not possible. Towards this end, owners and operators of gaming apparatus where coins are required to play the game would benefit from a system and method to initially activate the gaming apparatus with another form of currency, such as but not limited to a debit or credit card.

### BRIEF DESCRIPTION OF THE INVENTION

Embodiments of the invention relate to a system, method, and computer software code re-using a coin in an apparatus that requires the coin to operate the apparatus. The system comprises a currency insertion device, and an activation device configured to activate the apparatus once currency provided to the currency insertion device has been validated. The system further comprises a holding bin configured to hold at least one coin, and a collection device configured to capture the at least one coin when activation ceases.

The method comprises electronically activating the apparatus with a form of currency, and automatically releasing at least one coin for use within the apparatus once activated. The method further comprises collecting the at least one coin once activation ceases, and storing the at least one coin for a next activation of the apparatus. Each element of the method is accomplished without human interaction.

The computer software code is stored on a computer readable media and is executable with a processor. The computer software code comprises a computer software module for electronically activating the apparatus with a form of currency, when executed with the processor, and a computer software module for commanding automatic release of at least one coin for use within the apparatus once activated, when executed with the processor. The computer software code further comprises a computer software module for commanding collection and storing of the at least one coin once activation ceases, when executed with the processor.

### BRIEF DESCRIPTION OF THE DRAWING

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 depicts a block diagram illustrating a system for re-using a same coin when a card is used to activate the system;

FIG. 2 depicts a block diagram illustrating a system for re-using a same coin when currency is used to activate the system;

FIG. 3 is a side view of an exemplary embodiment of a gaming system/apparatus that re-uses a same coin; and

FIG. 4 is a flowchart that depicts a method for re-using a same coin in a gaming system/apparatus.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

Though exemplary embodiments of the present invention are described with respect to coin-operated apparatus used for playing a game, embodiments may be used with other coin-operated apparatus, such as but not limited to coin-operated washing machines and dryers that are typically found at a Laundromat.

Exemplary embodiments of the invention solve problems in the art by providing a system, method, and computer implemented method, such as a computer software code and/or computer readable media operated in a processor unique to a gaming apparatus, for providing a coin for use within the gaming apparatus when an credit card and/or ATM card is used to activate the gaming apparatus.

Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

Broadly speaking, a technical effect is re-using a coin for multiple users when a gaming system is activated with electronic and/or paper currency. To facilitate an understanding of the exemplary embodiments of the invention, it is described hereinafter with reference to specific implementations thereof. Exemplary embodiments of the invention may be described in the general context of computer-executable instructions, such as program modules, being executed by any device, such as but not limited to a computer, designed to accept data, perform prescribed mathematical and/or logical operations usually at high speed, where results of such operations may or may not be displayed. Generally, program modules, or computer software modules, include routines, programs, objects, components, data structures, etc., that perform particular tasks or implement particular abstract data types. For example, the software programs, or computer software code, which underlies exemplary embodiments of the invention, can be coded in different programming languages, for use with different devices, or platforms. It will be appreciated, however, that the principles that underlie exemplary embodiments of the invention can be implemented with any various types of computer software technologies.

Moreover, those skilled in the art will appreciate that exemplary embodiments of the invention may be practiced with other computer system configurations, including, multiprocessor systems, microprocessor-based or programmable consumer electronics, minicomputers, and the like. Exemplary embodiments of the invention may also be practiced in distributed computing environments where tasks are performed by remote processing devices that are linked through a communications network. In a distributed computing environment, program modules may be located in both local and remote computer storage media including memory storage devices.

Referring now to the drawings, embodiments of the present invention will be described. Exemplary embodiments of the invention can be implemented in numerous ways, including as a system, a method, an apparatus, a computer readable medium, a computer program product, or a data structure tangibly fixed in a computer readable memory. Several embodiments of the invention are discussed below.

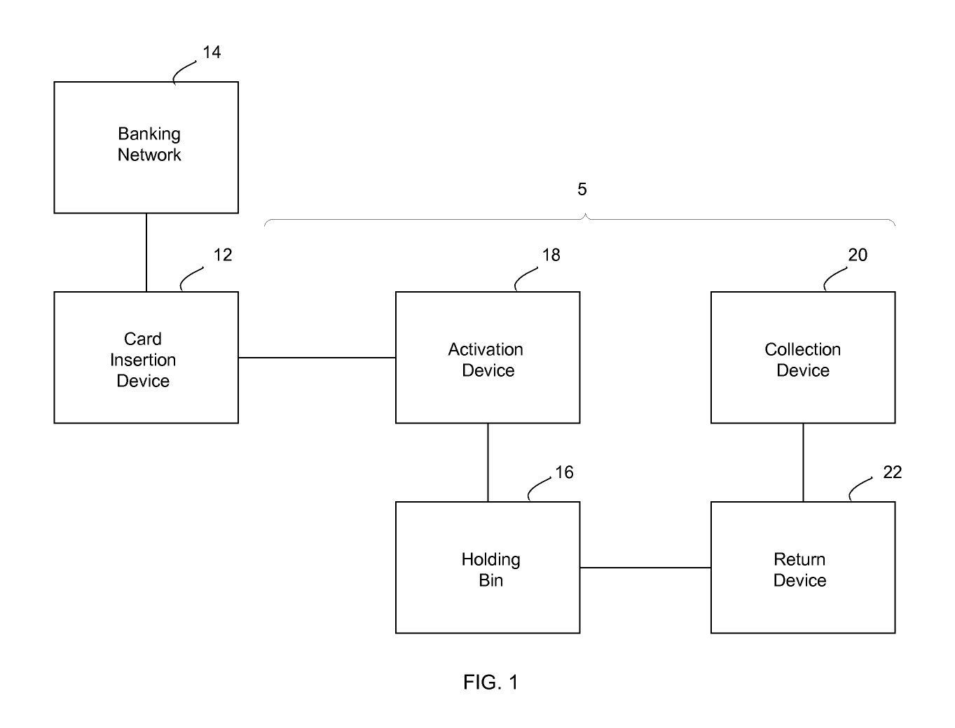

FIG. 1 depicts a block diagram illustrating a system for re-using a same coin. The type of coin used may be governmental currency or a specific coin designated for a specific entertainment location, commonly referred to as a token. The system 5 includes a debit or credit card insertion device, or simply card insertion device 12. The card insertion device 12 may be connected to a banking network 14, either through a wired connection and/or wireless connection, to determine whether the debit or credit card is associated with a financial account with sufficient money to operate the gaming apparatus wherein the appropriate money is deducted from the financial account. The card insertion device 12 is, in essence, a card reader, meaning it is able to read information contained on the card, and/or is able to active communication with the banking network 14. Those skilled in the art will recognize that the connection to the banking network 14 may be direct or through a network available at a location the gaming apparatus is located. Furthermore though the term “banking network” is used, the card may be unique to a specific location. For example, an entertainment location, such as but not limited to an arcade, may have its own “game” cards that a user may purchase. Therefore the banking network 14 may be centralized to the entertainment location and specific to a certain type of game card, which for this document is also considered a debit or credit card. In another embodiment, the card insertion device 12 comprises a card reader which can assess how much money is left on the game card, and to deduct the appropriate amount from the card for use with the gaming apparatus and/or system. Another type of card that may be defined as a debit or credit card is a gift card. Similar to the game card disclosed above, the card insertion device may be able to determine an amount of money left on a gift card, or communicate with a remote location that maintains this information.

A holding bin 16 is provided to store at least one coin. In an exemplary embodiment more than one coin may be stored. An activation device 18 is provided to release a coin for use by the user once the appropriate money is deducted from the financial account, by way of the debit, credit, game, and/or gift card. Though activation may be with the credit or debit card, a coin or paper currency may also activate the gaming apparatus. Thus, a coin insertion device and/or paper currency may also be available. When the gaming apparatus is activated with a coin, the activating coin may be the coin that is used when playing the apparatus or another, or second, coin waiting to be used next may be used during play. When the gaming apparatus is activated with paper currency, once the currency is verified, the system would operate similar to when a credit or debit card is used. Those skilled in the art will recognize that the paper currency insertion device will have a currency verification device as part of it. Furthermore, the paper currency is not limited to being government issued legal tender. The entertainment facility where the gaming system is used may have its own paper currency that may have its own unique designation signifying that it may be used in the gaming system.

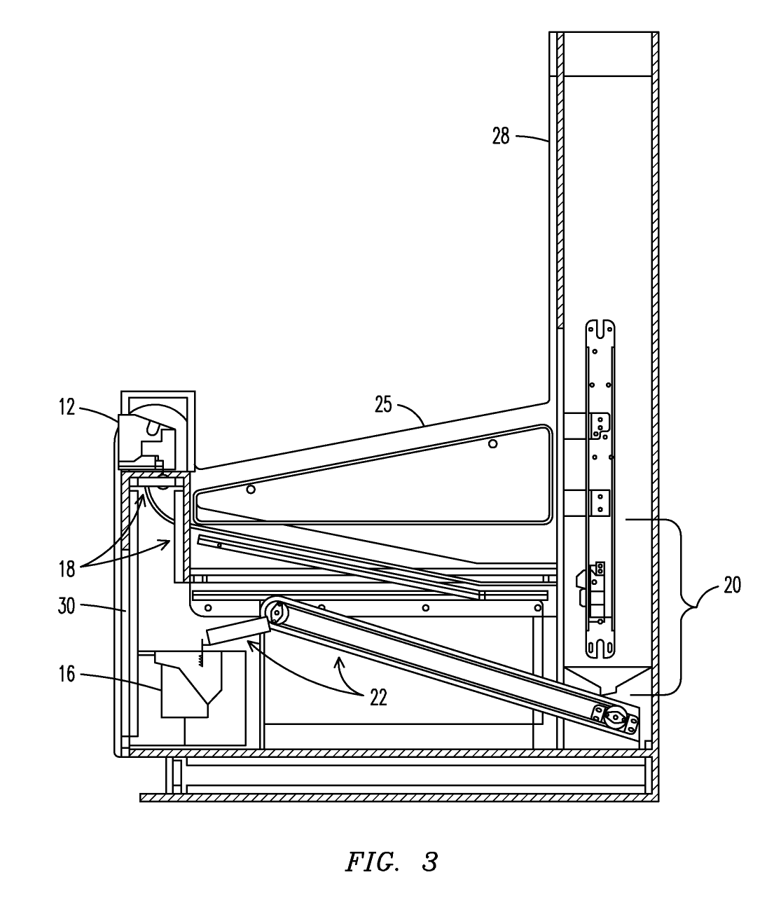

A collection device 20 is further provided to collect the coin once use of the coin is completed. A return device 22 is provided to return the coin to the holding bin 16, once it is collected. As illustrated in FIG. 3, the return device 22 is a conveyer-belt device which can relocate the coin to the holding bin 16. Though a conveyer-belt device is illustrated, those skilled in the art will readily recognize that a plurality of other devices may be used to relocate the coin to the holding bin 16. Once at the holding bin 16, the coin is available for use the next time activation of the game system occurs.

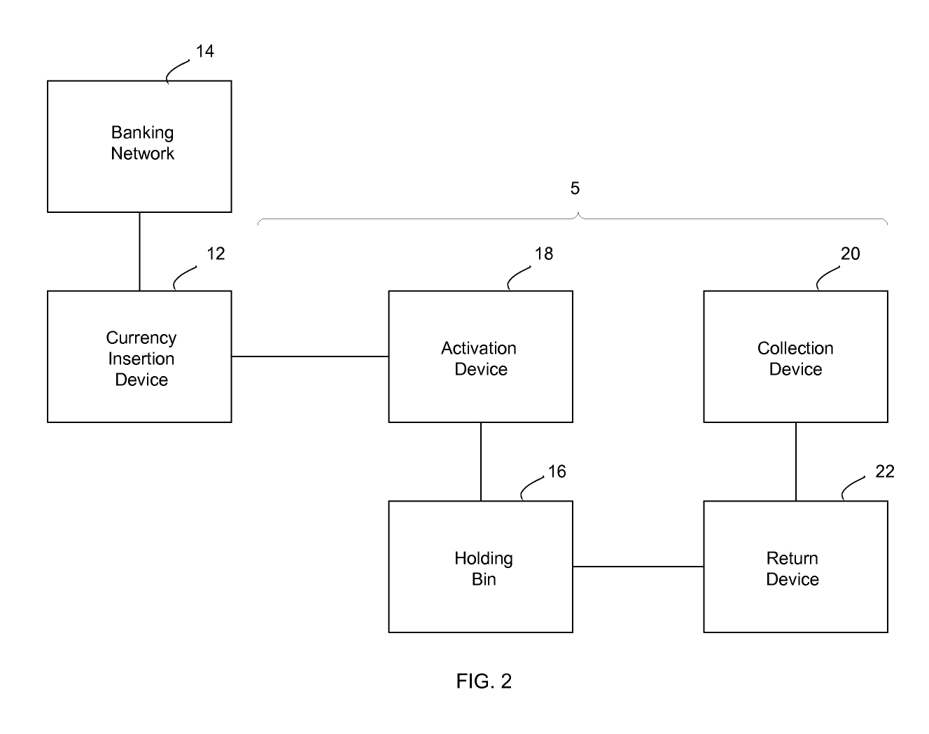

FIG. 2 depicts a block diagram illustrating a system for re-using a same coin when currency is used to activate the system. In place of the card insertion device 12 in FIG. 1, a currency insertion device 13 is provided. The currency insertion device is able to accept currency in any form, as previously discussed above. Once the currency is recognized as being acceptable, the system is activated by the activation device 18. The coin is then released from the holding bin 16. Once play is complete, the collection device 20 captures the coin and it is returned to the holding bin 16 by way of the return device 22.

FIG. 3 is a side view of an exemplary embodiment of a gaming apparatus for re-using a same coin. The gaming apparatus has a play area 25, or field of play, for a user to see the coin while the gaming system is activated, and/or a display area 28 for the user to determine if he/she is winning, how much time is left to play, and/or other information that may be of benefit to the user including a colorful display to attract the user to the system. The play area is mostly visible to the user, because there may be elements in the field of play that the coin passes into wherein the coin is no longer visible. The card insertion device 12 or currency insertion device 13 is further illustrated. Once the card is accepted, the activation device initiates the game by allowing a coin to be used in the game. The holding bin 16 is further illustrated, with a delivery system 30 to move the coin from the holding bin 16 to the field of play 25. Even though the holding bin 16 is illustrated with a slot to provide a coin to a user once the gaming system is activated, in another exemplary embodiment, a coin is provided directly to the user in a field of play, where “field of play” is defined as including a starting location where the coin would start if initially used while the gaming apparatus is activated. The collection device 20 is further illustrated, and so is the return device 22 to return the coin to the holding bin.

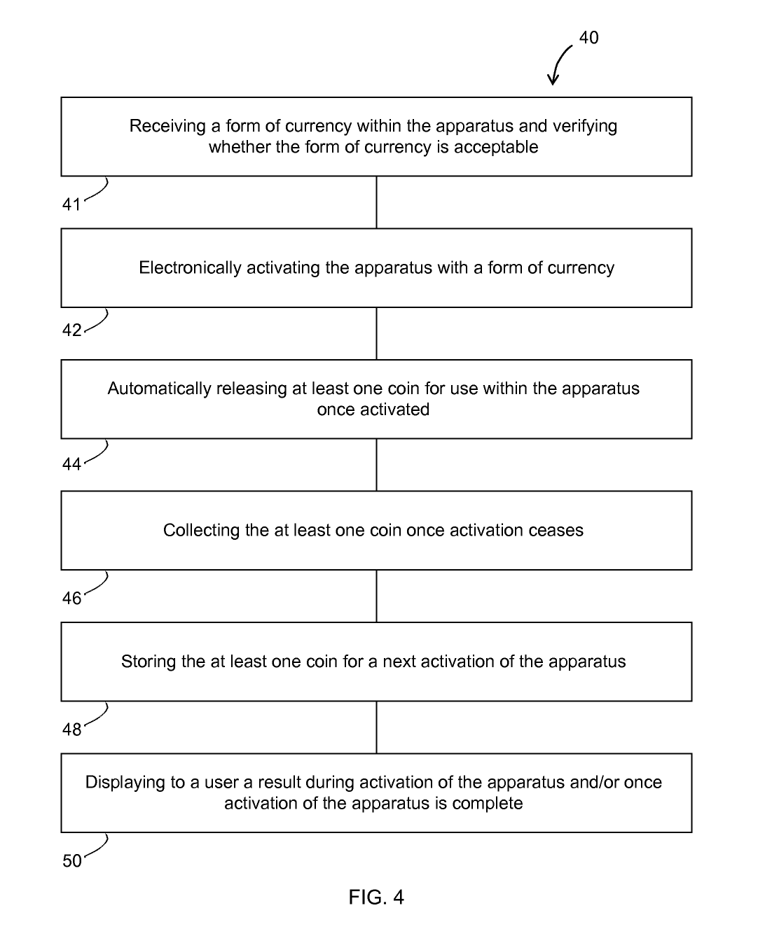

FIG. 4 is a flowchart 40 that depicts a method for re-using a same coin in a gaming apparatus. The method includes receiving a form of currency within the apparatus and verifying whether the form of currency is acceptable, at 41 and electronically activating the apparatus with a form of currency, at 42. The method also includes automatically releasing at least one coin for use within the apparatus once activated, at 44, and collecting the at least one coin once activation ceases, at 46. The method further includes storing the at least one coin for a next activation of the apparatus, at 48. Also included is displaying to a user a result during activation of the apparatus and/or once activation of the apparatus is complete, at 50.

Those skilled in the art will readily recognize that the method shown in FIG. 4 may be implemented with a computer software code that is storable on computer media and is operatable with a processor. Though not illustrated, the processor may be a part of the activation device 18, and/or may be an independent processor.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A system for re-using a coin in an apparatus that requires the coin to operate the apparatus, the system comprising:
a currency insertion device;
an activation device configured to activate the apparatus once currency provided to the currency insertion device has been validated;
a holding bin configured to hold at least one coin; and
a collection device configured to capture the at least one coin when activation ceases.

2. The system according to claim 1, further comprising a return device to return the at least one coin to the holding bin.

3. The system according to claim 1, wherein the currency insertion device is a card insertion device, a paper currency insertion device, and/or a coin insertion device.

4. The system according to claim 1, further comprising a banking network configured to inform the currency insertion device whether the currency provided is acceptable currency.

5. The system according to claim 4, wherein the banking network is further configured to deduct an appropriate amount from a financial account when a credit card, debit card, and/or gift card is used with the currency insertion device.

6. The system according to claim 1, further comprising a play area mostly visible to a user to witness the coin as it is used during activation of the apparatus.

7. The system according to claim 1, further comprising a display area.

8. The system according to claim 1, wherein the apparatus is a gaming system.

9. A method re-using a coin in an apparatus that requires the coin to operate the apparatus, the method comprising:
electronically activating the apparatus with a form of currency;
automatically releasing at least one coin for use within the apparatus once activated;
collecting the at least one coin once activation ceases; and
storing the at least one coin for a next activation of the apparatus.

10. The method according to claim 9, wherein electronically activating the apparatus further comprises activating the apparatus with a debit card, a credit card, and/or a gift card.

11. The method according to claim 10, further comprising verifying the debit card, credit card, and/or gift card through a banking network.

12. The method according to claim 9, wherein electronically activating the apparatus further comprises activating the apparatus with at least one coin and/or paper currency.

13. The method according to claim 11, further comprising deducting an appropriate amount from a financial account when the credit card, debit card, and/or gift card is used to activate the apparatus.

14. The method according to claim 9, further comprising displaying to a user a result during activation of the apparatus and/or once activation of the apparatus is complete.

15. The method according to claim 9, further comprising receiving a form of currency within the apparatus and verifying whether the form of currency is acceptable.

16. The method according to claim 9, wherein the apparatus is a gaming system.

17. A computer software code stored on a computer readable media and executable with a processor for re-using a coin in an apparatus that requires the coin to operate the apparatus, the computer software code comprising:
a computer software module for electronically activating the apparatus with a form of currency, when executed with the processor;
a computer software module for commanding automatic release of at least one coin for use within the apparatus once activated, when executed with the processor; and
a computer software module for commanding collection and storing of the at least one coin once activation ceases, when executed with the processor.

18. The computer software code according to claim 17, further comprising a computer software module for verifying whether the form of currency used to activate the apparatus is acceptable, when executed with the processor.

19. The computer software code according to claim 17, further comprising a computer software module for displaying to a user a result during activation of the apparatus and/or once activation of the apparatus is complete, when executed with the processor.
